(19) United States
(12) Patent Application Publication
(10) Pub. No.: US 2023/0085882 A1
(43) Pub. Date: Mar. 23, 2023

(54) BUSBAR BYPASS FOR BATTERY MONITORS

(71) Applicant: TEXAS INSTRUMENTS INCORPORATED, Dallas, TX (US)

(72) Inventors: Tahar ALLAG, Irving, TX (US); Jose Antonio Vieira FORMENTI, Dallas, TX (US)

(21) Appl. No.: 17/876,612

(22) Filed: Jul. 29, 2022

Related U.S. Application Data
(60) Provisional application No. 63/246,398, filed on Sep. 21, 2021.

(51) Int. Cl. H01M 10/48; H02J 7/00; H01M 50/569; H01M 50/502; H01M 10/42; B60L 53/22; B60L 58/10

(52) U.S. Cl. CPC H01M 10/482; H02J 7/00304; H02J 7/0013; H02J 7/0047; H01M 50/569; H01M 50/502; H01M 10/425; B60L 53/22; B60L 58/10; H01M 2220/20; H01M 2010/4271

(57) ABSTRACT

A system includes a first multiplexer and a second multiplexer. The first multiplexer has a first multiplexer input, a second multiplexer input, and a first multiplexer output. The second multiplexer has a third multiplexer input, a fourth multiplexer input, and a second multiplexer output. A first analog-to-digital converter (ADC) has a first ADC input and a second ADC input. The first ADC input is coupled to the first multiplexer output. A second ADC has a third ADC input and a fourth ADC input. The third ADC input is coupled to the second multiplexer output. A first measurement channel pin is coupled to the first multiplexer input and to the third ADC input. A busbar pin is coupled to the second multiplexer input and the third multiplexer input.

### CROSS-REFERENCE TO RELATED APPLICATIONS

This application claims priority to U.S. Provisional Application No. 63/246,398, filed Sep. 21, 2021, which is hereby incorporated by reference.

### BACKGROUND

Some systems include multiple battery modules, Each battery module includes multiple battery cells connected in series. The battery modules may be connected in series to form a stack of batteries. A busbar may be used to connect one battery module to another. Electric vehicles (EVs) may include multiple battery modules connected in series to provide, for example, a 400V or 800V voltage source.

Battery monitors (e.g., integrated circuits) are used to measure the voltage of individual battery cells in battery modules during charging or discharging of the battery modules. The charge or discharge current also flows through the busbar and results in a voltage drop across the busbar itself. For some battery monitors, the busbar voltage may be included in series with the voltage of the first battery cell in a battery module that is connected to the busbar. Some battery modules may include a voltage measuring channel that is dedicated to measuring the voltage across the busbar. Such battery monitors then may subtract the busbar voltage from the voltage measured for the first cell in the module (which also includes the busbar voltage) to obtain the voltage of the first cell.

### SUMMARY

In one example, a system includes a first multiplexer and a second multiplexer. The first multiplexer has a first multiplexer input, a second multiplexer input, and a first multiplexer output. The second multiplexer has a third multiplexer input, a fourth multiplexer input, and a second multiplexer output. A first analog-to-digital converter (ADC) has a first ADC input and a second ADC input. The first ADC input is coupled to the first multiplexer output. A second ADC has a third ADC input and a fourth ADC input. The third ADC input is coupled to the second multiplexer output. A first measurement channel pin is coupled to the first multiplexer input and to the third ADC input. A busbar pin is coupled to the second multiplexer input and the third multiplexer input.

### BRIEF DESCRIPTION OF THE DRAWINGS

FIG. 1 is a block diagram illustrating a monitoring system, in accordance with an example.

FIG. 2 is a block diagram of a portion of a battery monitoring system connected to at least one battery module and a busbar, in accordance with an example.

FIG. 3 is a schematic illustrating a portion of a battery monitoring system connected to at least one battery cell and a busbar, in accordance with an example.

FIG. 4 is a flowchart illustrating a process for monitoring a voltage value of a voltage cell while bypassing a busbar voltage, in accordance with an example.

### DETAILED DESCRIPTION

The same reference number or other type of designator is used in the drawings for the same or similar (either by function and/or structure) features.

In one or more embodiments, one or more battery monitors may be used to measure voltages of battery cells within battery modules. A battery module may include multiple battery cells with each battery cell being monitored individually by a battery monitor. Battery modules may be connected in series via busbars. In a technical environment, any two battery modules may be connected by a busbar. In accordance with one or more embodiments, a voltage value of a battery cell adjacent to the busbar may be monitored individually without being affected by the voltage of the busbar. In these embodiments, the voltage of the busbar is bypassed while obtaining the voltages of the battery cells connected next to the busbar in series. The voltage of each battery cell may be determined using measurement channels that measure the voltage of a next battery cell with respect to the voltage of a previous battery cell connected in series. To avoid measurement and subtraction of the voltage generated by the small resistance of the busbar, the measurement channel configured to receive the voltage of a battery cell adjacent to the busbar receives the voltage of the battery cell with respect to a voltage of the busbar provided via a single connection (e.g., input) pin. The single connection pin is different from the measurement channels given that it is only connected to multiplexers. The measurement channels need at least two pins, and additional front end analog components and materials to regulate voltage collected by the at least two pins. The voltage of any adjacent battery cell to the busbar may be determined based on a difference between the voltage at the battery cell and the voltage at the busbar. As a result, battery monitors monitoring the voltages of individual battery cells may include a number of channels that is equal to a number of battery cells in a monitoring system (a channel dedicated to just measuring the busbar voltage is not needed).

In some embodiments, the described battery monitor may be used in technical environments in which at least two battery modules are connected via a busbar. Examples of technical environments include battery monitoring applications, battery management systems (BMS), electric vehicles (EVs), and hybrid vehicles (HVs). These technical environments may include battery modules configured to supply power to one or more systems. For example, in an EV, the battery modules may be configured to provide power to all systems and electronic devices of the EV. Multiple battery modules may be connected in series via busbars to provide a voltage of, for example, 400 Volts (V), 800V, etc.

The number of cells in a given module may vary from, for example, 2 cells in series to over 100 cells in series. In some embodiments, multiple battery monitors may be used to monitor the individual cells of all of the battery modules in the series stack of modules. A given battery monitor may individually monitor battery cells in adjacent battery modules connected via a busbar. In some embodiments, the battery monitor may monitor the individual battery cells to which it is connected without using software to subtract the voltage of the busbar from voltage measured for a battery cell that also includes the busbar voltage. The voltage at each battery cell may be measured using respective dedicated measurement channels within the battery module while bypassing the voltage of the busbar.

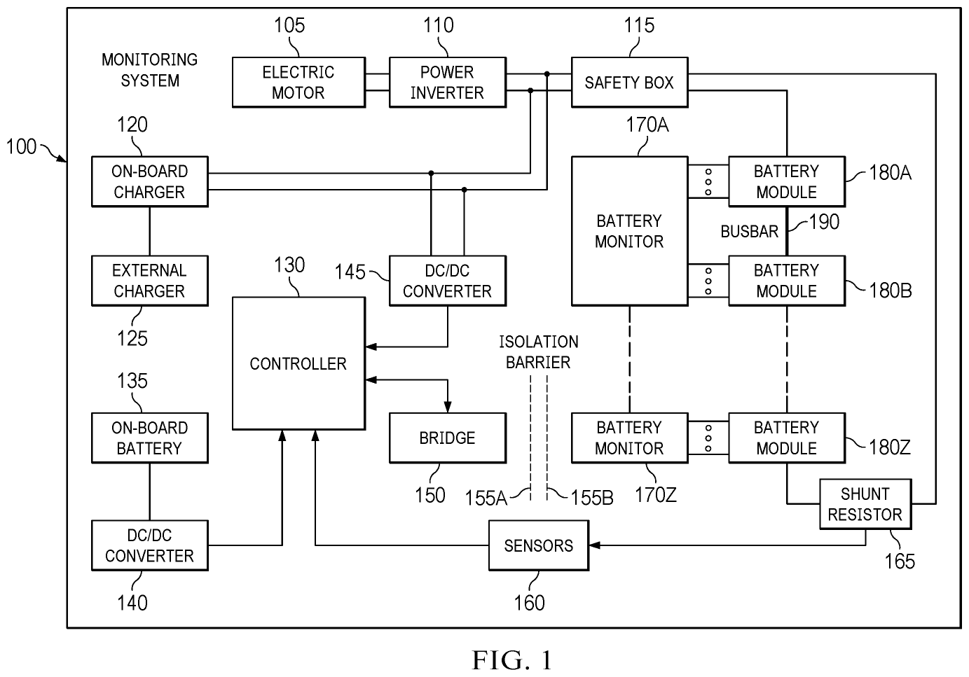

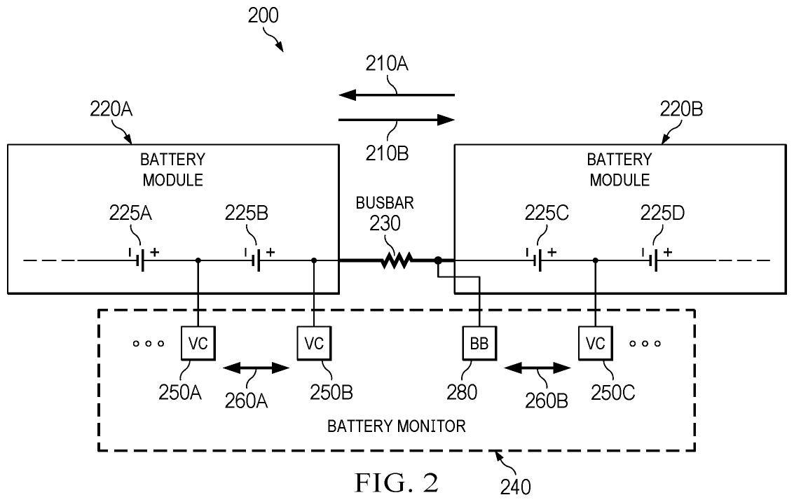

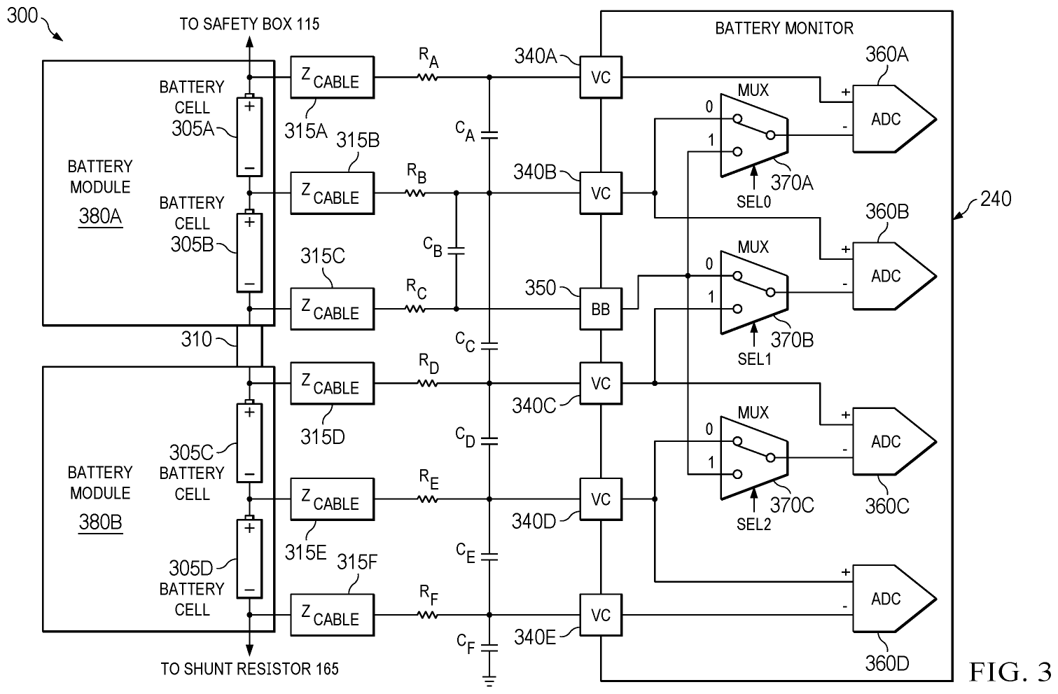

FIG. 1 is a block diagram illustrating an embodiment of a system 100 in accordance with one or more embodiments. The system 100 uses multiple battery monitors 170A and 170B (collectively, battery monitors 170) to monitor voltages of battery cells in multiple battery modules 180A, 180B, and 180Z (collectively, battery modules 180). Battery modules 180A and 180B are shown interconnected by way of busbar 190. Additional busbars 190 may be included to interconnect other pairs of battery modules to form a series chain of battery cells. The number of battery monitors 170 included in the system 100 depends on the number of battery modules 180 to be monitored and the number of cells in each such module. In one example, the number of battery monitors 170 is less than the number of battery modules 180 being monitored. Each battery monitor 170 may be configured to monitor the voltages of individual battery cells in one or more battery modules 180 connected via busbars. In this example, the battery monitors 170 monitor the voltages of the battery cells while bypassing voltages of any connecting busbars 190. In FIG. 1, the battery monitor 170A is configured to monitor battery modules 180A and 180 and a connecting busbar 190. Further, the battery monitor 170Z is configured to monitor battery module 180Z. In these embodiments, the battery monitors 170 provide multiple measurement channels to the battery modules to measure the individual battery cell voltages of the modules. The busbar voltages may be referenced using a dedicated input pin without using a corresponding (e.g. respective) measurement channel within the monitors. The connections between the battery monitors 170 and the battery modules 180 and the busbar 190 will be described in more detail in FIGS. 2 and 3.

In the example of FIG. 1, the system 100 is a Battery Monitoring System (BMS) configured for industrial or automotive applications. The battery monitors 170 may be networked together using any suitable type of interface such as two-wire interfaces including, for example, Controller Area Network (CAN bus), Ethernet, or SPI. The battery monitors 170 may communicate with a controller 130 via a communications line and a bridge 150. The communications line may have galvanic isolation using an Ethernet LAN transformer. The isolation barrier prevents hazardous voltages measured by the battery monitors 170 in high voltage lines 155B from being imposed onto low voltage lines 155A. A level of isolation (e.g., basic, supplementary, double, and reinforced) may be configured in accordance with one or more applications of the system 100. The level of isolation may be configured in accordance with one or more specific safety standards (e.g., Automotive Safety Integrity Level (ASIL) or International Organization for Standardization (ISO) standards for signal transmission reliability in motor vehicles). The bridge 150 may forward information and commands between the battery monitors 170 and the controller 130. For example, the controller 130 selects an input position of one or more multiplexers located in the battery monitors 170 (shown in FIG. 3) using one or more command signals. The controller 130 is configured to receive voltage, current, and temperature measurements from the battery monitors 170 and the sensors 160. In this example, the controller 130 may include one or more processors (e.g., microcontrollers configured to execute software) configured to coordinate some or all actions and operations within the system 100.

Current and temperature measurements of the battery modules 180 may be obtained using sensors 160 connected in parallel with a shunt resistor 165 that is in turn connected in series with the battery modules 180 after the last battery module of the series stack of battery modules. The sensors 160 may include multiple electronic components (capacitors, resistors, transistors, and the like) arranged to perform the functions of an ADC, current sensing, and temperature sensing. In some embodiments, the sensors 160 may be configured to perform voltage measurements of the shunt resistor 165, convert the voltage using a dedicated ADC, and calculate a corresponding current through the shunt resistor 165. The sensors 160 may be configured to obtain temperature measurements using a Negative Temperature Coefficient (NTC) resistor/thermostat, or one or more thermistors to measure the temperature at the shunt resistor 165 based on the current values obtained.

The system 100 includes a safety box 115 that operates as a high-speed overcurrent protection device for power forwarded from an on-board charger 120 to charge the battery modules 180 or from the battery modules 180 to power a load such as an electric motor 105. The safety box 115 may include a combination of solid-state switches or fuses that trip (e.g., turn OFF or open) responsive to an overcurrent in the line to/from the battery modules.

The battery modules 180 store electrical energy to power the electric motor 205 and/or other electronics. A power inverter 110 converts the DC voltage from the battery modules 180 to a time varying voltage (e.g., sinusoidal voltage/current) to drive the electric motor 105. In the context of an EV, the electronics may be automotive devices or systems such as the heating, ventilation, and air conditioning (HVAC) system (not shown), window control operations (not shown), etc. In an EV, the electric motor 105 may cause the vehicle to move forward or in reverse.

Referring still to FIG. 1, the system 100 also includes an on-board charger 120 connected to an external charger 125 to charge the battery modules 180 directly from an external power source such an electrical grid. A direct current (DC)/DC converter 145 steps down the voltage produced by the on-board charger 120 or from the battery modules to provide a reduced voltage (e.g., 5V) to the controller 130.

An on-board battery 135 coupled with a DC/DC converter 140 provides additional power to the controller 130. The on-board battery 135 may produce a substantially smaller voltage (12V) than the series combination of battery modules (e.g., 400V). This additional power may be redundant power to maintain the controller 130 powered at a constant voltage while the system 100 transitions in and out of charging operations.

FIG. 2 shows a block diagram of a portion 200 of a battery monitoring system in accordance with one or more embodiments. In this example, a battery monitor 240 (which may be a battery monitor 170 as in FIG. 1) is connected to two battery modules 220A and 220B (collectively battery modules 220) and a busbar 230. Battery modules 220 may be two of the battery modules 180 in FIG. 1, and the busbar 230 may be the busbar 190 shown in FIG. 1. Each battery module 320 includes multiple battery cells. Two cells are shown in each battery module (individual battery cells 225A-225D or collectively battery cells 225), but more than two cells may be included as desired. The battery cells are connected in series within each module, with end battery cells 225A and 225D of the respective battery modules 220A and 220B connected in series by way of busbar 230.

As indicated by arrows 210A and 210B, a current flow in the battery stack may occur in either direction in accordance with a charging operation or a discharging operation, respectively. During the charging operation, voltage is accumulated by the on-board charger 120, and current flows from the anode (positive terminal) to the cathode (negative terminal) of each cell (represented by arrow 210A pointing to the left). During the discharging operation, voltage is supplied by the battery stack to a load (e.g., the electric motor) and current flows from the cathode to the anode of each cell (represented by arrow 210B).

The battery monitor 240 includes multiple inputs (labeled as “VC”) connected to the nodes between battery cells. For example, inputs of VC measurement channels 250A and 250B are connected to the negative and positive terminals, respectively of battery cell 325A. The VC inputs correspond to measurement channels 250A, 250B, and 250C (collectively, measurement channels 250) connected to each battery cell in the battery modules 220. Input 280 is labeled “BB” and is connected to one end of the busbar 230 as shown. The VC measurement channels 250 receive the voltage corresponding to a respective battery cell 225, and BB input 280 receives the voltage corresponding to one end of the busbar 230. In this example, the measurement channel 250A is connected to the cathode of battery cell 225B in battery module 220A, which is the anode of a previous battery cell 225A. The measurement channel 250B is connected to the anode of the battery cell 225B. The BB input 280 is connected to one end of the busbar 230 that coincides with the cathode of a battery cell 225C in battery module 220B. The measurement channel 250C is connected to the anode of the battery cell 225C.

The battery monitor 240 is configured to determine voltage drops between consecutive measurement channels 250 and/or between a measurement channel and the BB input 280. In accordance with some embodiments, measurements of the voltage difference across the busbar 190 itself may be avoided while the voltages of individual the battery cells 225 are obtained. As described herein, the battery cells 225 may be located in battery modules 220 connected to one another using busbars. In the example of FIG. 2, the battery monitor 240 is configured to determine a voltage drop between the measurement channel 250C and the BB input 280. As a result, at any given time, the battery monitor 240 receives a battery voltage 260A corresponding to the battery cell 225B and a battery voltage 260B corresponding to the battery cell 225C while avoiding receiving the voltage of the busbar 190.

FIG. 3 is a schematic of a portion 300 of a battery monitoring system in accordance with one or more embodiments. In this example, the battery monitor 240 is connected to two battery modules 380A and 380B (collectively, battery modules 380) and a busbar 310. The battery module 240 may be connected to one or more additional battery modules. Each battery module 380 is shown to include only two battery cells (collectively, battery cells 405), but each module can include more than two battery cells in other embodiments. In this example, a battery module 380A includes a battery cell 305A and a battery cell 305B. A battery module 380B includes a battery cell 305C and a battery cell 305D. The battery modules 380 are shown to be connected via a busbar 310. In this configuration, all four battery cells 305A-305D are connected in series as shown. In the portion 300, the anode of the battery cell 305A may be connected to the safety box 115 in the manner described in reference to FIG. 1. Further, the cathode of the battery cell 305D may be connected to the shunt resistor 165 in the manner described in reference to FIG. 1.

In the example shown in FIG. 3, the battery module 240 is configured to monitor the voltage of four battery cells in the battery modules 380 using four measurement channels 340A-340D (collectively, measurement channels 340) and a BB input 350. In this example, the battery module 240 includes a set of analog-to-digital converters (ADCs) 360A-460D (collectively, ADCs 360) that matches the number of measurement channels 340. Each ADC 360 can be implemented using any suitable type of ADC architecture such as a sigma-delta ADC. The BB input 350 is coupled to multiplexers 370A-370C (collectively, multiplexers 370) to provide signal paths in which any measurement channel may be configured to exclude the voltage of the busbar 310 from any voltage calculations.

Each multiplexer 370 includes two voltage inputs and a selection input. Either of the two voltage inputs can be coupled to the output as specified by the logic state of a selection signal (SELO, SELS1, and SEL2 provided to multiplexers 370A, 370B, and 370C, respectively). The SELECT signal may be provided by, for example, the controller 130 described in FIG. 1 through the bridge 150. The BB input 350 is coupled to one input of each of the multiplexers 370. The other input of each of the multiplexers 370 is coupled to one of the measurement channels 340.

In the example of FIG. 3, the anode of the battery cell 305A is connected to the positive terminal of the ADC 360A via the measurement channel 340A. The anode of the battery cell 305B is connected to the measurement channel 340B. The measurement channel 340B is coupled to the 0-input terminal of the multiplexer 370A and the positive terminal of the ADC 360B. An output of the multiplexer 370A is coupled to the negative terminal of the ADC 360A. Based on the logic state of the selection signal SELO, the 0-input terminal and the 1-input may connect the measurement channel 340B and the BB input 350 to the negative terminal of the ADC 360A, respectively. One end of the busbar 310 is connected to the BB input 350. In this example, the BB input 350 is coupled to the 1-input of the multiplexer 370A, the 0-input of the multiplexer 370B, and the 1-input of the multiplexer 370C. The anode of the battery cell 305C is connected to the measurement channel 340C. The measurement channel 340C is coupled to the 1-input terminal of the multiplexer 370B and the positive terminal of the ADC 360C. An output of the multiplexer 370B is coupled to the negative terminal of the ADC 360B. Based on the logic state of the selection signal SEL1, the 0-input terminal and the 1-input may connect the BB input 350 and the measurement channel 340C to the negative terminal of the ADC 360B, respectively. The anode of the battery cell 305D is connected to the measurement channel 340D. The measurement channel 340D is coupled to the 0-input terminal of the multiplexer 370C and the positive terminal of the ADC 360D. An output of the multiplexer 370C is coupled to the negative terminal of the ADC 360C. Based on the logic state of the selection signal SEL2, the 0-input terminal and the 1-input may connect the measurement channel 340D and the BB input 350 to the negative terminal of the ADC 360C, respectively. The cathode of the battery cell 305D is coupled to a VC ground terminal 340E and the negative terminal of the ADC 360D. The VC ground terminal 340E is a local ground terminal through a shunt resistor (e.g., shunt resistor 165). As mentioned above, the input of the multiplexers 370 is selected using one of the corresponding SELECT signals described above. The controller 130 can independently control the logic state of the multiplexers 370. In this example, if the controller 130 commands (via the selection signals) at least one of the multiplexers 370 to connect to the BB input 350, the controller 130 commands all other multiplexers 370 (directly or inherently) to connect to one of the measurement channels 340.

In FIG. 3, each connection is shown to include a corresponding cable impedance 315A-315F and a corresponding resistance RA-RF. The separation between connections may cause negligible parasitic capacitances (represented via capacitances CA-CE). Each ADC 360 converts the voltage difference between its inputs to a digital value. Under the connections shown in FIG. 3, the ADC 360A converts the voltage difference between the measurement channel 340A and the measurement channel 340B. The ADC 360B converts the voltage difference between the measurement channel 340B and the BB input 350. The ADC 360C converts the voltage difference between the measurement channel 340C and the measurement channel 340D. The ADC 360D converts the voltage difference between the measurement channel 340D and the VC ground terminal 340E.

A ground connection is connected to the VC ground terminal 340E via the capacitor CF. The VC ground terminal 340E is not directly connected to the ground connection. Instead, the VC ground terminal 340E is connected to the ground connection through a differential filter incorporated via the capacitor CF.

In the aforementioned connections, the ADC 360A produces a digital output value that is proportional to the voltage drop between the anode of the battery cell 305A and the anode of the battery cell 305B. This digital output value is provided to the controller 130 and is interpreted by the controller 130 as a voltage of the battery cell 305A. The ADC 360B converts a voltage drop between the anode of the battery cell 305B and the one end of the busbar 310. This digital output value is provided to the controller 130 and is interpreted by the controller 130 as a voltage of the battery cell 305B. The ADC 360C converts a voltage drop between the anode of the battery cell 305C and the anode of the battery cell 305D. This digital output value is provided to the controller 130 and is interpreted by the controller 130 as a voltage of the battery cell 305C. The ADC 360D converts a voltage drop between the anode and the cathode of the battery cell 305D. The cathode of the battery cell 305D is also the VC ground terminal 340E. This digital output value is provided to the controller 130 and is interpreted by the controller 130 as a voltage of the battery cell 305D.

In one or more embodiments, the aforementioned voltages (e.g., their digital equivalent values) are obtained without requiring software intervention to subtract the voltage across the busbar 310. The multiplexers 370 may be individually configured to select a path that excludes the busbar 310 between any two battery modules when measuring a voltage in a battery cell. For example, based on the application, two consecutive battery modules (interconnected by a busbar) may be unevenly matched to the number of measurement channels available in the battery module. In this case, the BB input 350 may be configured to connect to the busbar between any two measurement channels. In this example, the voltage of the busbar is not measured and digitized as long as a corresponding multiplexer is selected for an ADC conversion. In FIG. 3, if the busbar 310 were to be located between the battery cell 305C and the battery cell 305D, the BB input 350 could be coupled to an end of a busbar placed between the measurement channel 340C and the measurement channel 340D. In this configuration, to avoid collecting the voltage of the busbar 310 (e.g., bypassing the busbar voltage), the controller 130 may command the multiplexer 370C to select a path of the 1-input to connect the BB input 350 to the negative terminal of the ADC 360C. Under this selection, the ADC 360C converts the voltage between the measurement channel 340C and the BB input 350 to obtain the voltage across the battery cell 305C.

In one or more embodiments, no external components, monitor channel waiting, or software complexity are needed to measure the individual voltages across battery cells. The battery monitors described herein may be configured by selecting a busbar bypass option and obtaining the voltages of the individual battery cells without measuring the voltage drop across the busbar. The flexible coupling of the busbar at any of multiple locations in a battery module allows for a variety of module cell counts to be measured.

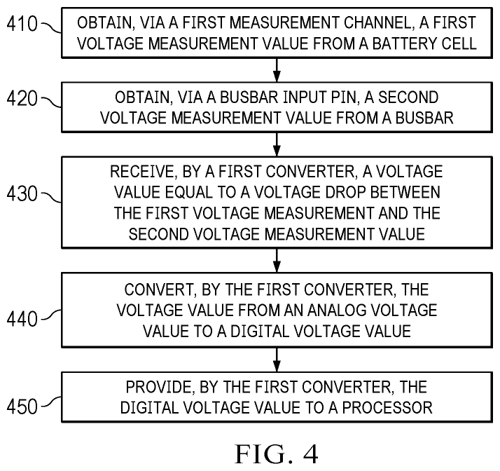

FIG. 4 is a flowchart that illustrates a method for individually collecting the voltage of multiple battery cells in accordance with one or more embodiments. Specifically, FIG. 4 shows a method for measuring the individual voltage of the battery cells located adjacent to a busbar while bypassing the voltage of the busbar. The method may be implemented using the battery monitors 170 or 240 described in reference to FIGS. 1-3. While the various blocks in FIG. 4 are presented sequentially and in a particular order, the order can be varied and two or more of the blocks may be executed in parallel.

At 410, a battery module obtains, via a first measurement channel, a first voltage measurement value for a battery cell. At this point, the battery module may receive a first voltage reference value at one of the ADCs via a corresponding measurement channel. In the example of FIG. 3, this step may refer to the battery module 240 obtaining a voltage reference value from the anode of the battery cell 305B via the measurement channel 240B. The first voltage measurement value may be received at the positive terminal of the ADC 360B.

At 420, the battery module obtains, via a dedicated busbar input pin, a second voltage measurement value for a busbar. The battery module may receive a second voltage reference value at the same ADC where the first voltage reference value was received. Following the example in FIG. 3, this step may refer to the battery module 240 obtaining a voltage reference value from one end of the busbar 310 via the BB input 350. The second voltage measurement value may be received at the negative terminal of the ADC 360B.

At 430, a first converter receives a voltage value across the first battery cell based on a voltage difference between the first voltage measurement value and the second voltage measurement value. As described above, the ADC receives the first voltage measurement value and the second voltage measurement value as different inputs on the positive terminal and the negative terminal, respectively. At this point, the ADC 360B receives a voltage value that is equal to the difference between the first voltage measurement value and the second voltage measurement value.

At 440, the first converter converts the voltage value across the first battery cell. At this stage, the voltage value across the battery cell is converted from an analog type to a digital type. Upon receiving the voltage, the ADC 360B converts the voltage received from the previous step.

At 450, the first converter provides the converted voltage value to a processor. The processor may be the controller 130 described in reference to FIG. 1. In this step, the ADC 360 forwards the converted voltage to the controller 130. The controller 130 in turn receives the converted voltage in as a value of the digital type.

The flowchart ends at 460, the processor identifies the converted voltage value as a first voltage cell value corresponding to the first battery cell. In this step, the processor determines that the converted voltage value is an individual voltage value of the battery cell. In this case, despite the battery cell being adjacent to the busbar, the busbar voltage is not measured or received by any of the ADCs. Instead, the voltage of the busbar is avoided to only measure the voltage across the battery cell.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in another example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter.

Modifications are possible in the described embodiments, and other embodiments are possible, within the scope of the claims.

What is claimed is:

1. A system, comprising:
a first multiplexer having a first multiplexer input, a second multiplexer input, and a first multiplexer output;
a second multiplexer having a third multiplexer input, a fourth multiplexer input, and a second multiplexer output;
a first analog-to-digital converter (ADC) having a first ADC input and a second ADC input, the first ADC input coupled to the first multiplexer output;
a second ADC having a third ADC input and a fourth ADC input, the third ADC input coupled to the second multiplexer output;
a first measurement channel pin coupled to the first multiplexer input and to the third ADC input; and
a busbar pin coupled to the second multiplexer input and the third multiplexer input.

2. The system of claim 1, further including a controller, and wherein:
each of the first and second multiplexers has a respective selection input coupled to the controller; and
the controller is configured to control the first and second multiplexers such that the busbar pin is connected to only one of the first or second ADCs at any point in time.

3. The system of claim 1, further comprising:
a third ADC having a fifth ADC input and a sixth ADC input, the third ADC input coupled to the second multiplexer output;
a third multiplexer having a fifth multiplexer input, a sixth multiplexer input, and a third multiplexer output, the third multiplexer output coupled to the sixth ADC input;
a second measurement channel pin coupled to the fourth multiplexer input and to the sixth ADC input; and
a third measurement channel pin coupled to the fifth multiplexer input; and
wherein the busbar pin is coupled to the sixth multiplexer input.

4. The system of claim 3, further including a controller, and wherein:
each of the first, second, and third multiplexers has a respective selection input coupled to the controller; and
the controller is configured to control the first, second, and third multiplexers such that the busbar pin is connected to only one of the first, second, or third ADCs at any point in time.

5. The system of claim 1, wherein the first measurement channel pin is adapted to be coupled to a battery module.

6. A system, comprising:
a first battery module including a first number of battery cells, the first battery module having connection terminals between respective pairs of the battery cells of the first battery module;
a second battery module including a second number of battery cells, the second battery module having connection terminals between respective pairs of the battery cells of the second battery module;
a busbar coupling the first battery module to the second battery module; and
a battery monitor having a third number of measurement channel pins and a busbar pin, each connection terminal from the first and second battery modules coupled to a respective one of the measurement channel pins, and the busbar coupled to the busbar pin, wherein the third number is equal to a sum of the first number and the second number.

7. The system of claim 6, wherein the system is a vehicle.

8. The system of claim 6, wherein the third number of measurement channel pins includes a first measurement channel pin, and the battery monitory comprises:
a first multiplexer having a first multiplexer input, a second multiplexer input, and a first multiplexer output;
a second multiplexer having a third multiplexer input, a fourth multiplexer input, and a second multiplexer output;
a first analog-to-digital converter (ADC) having a first ADC input and a second ADC input, the first ADC input coupled to the first multiplexer output;
a second ADC having a third ADC input and a fourth ADC input, the third ADC input coupled to the second multiplexer output;
the first measurement channel pin coupled to the first multiplexer input and to the third ADC input; and
a busbar pin coupled to the second multiplexer input and the third multiplexer input.

9. The system of claim 8, further including a controller, wherein:
each of the first and second multiplexers has a respective selection input coupled to the controller; and
the controller is configured to control the first and second multiplexers such that the busbar pin is connected to only one of the first or second ADCs at any point in time.

10. The system of claim 8, wherein the battery monitor comprises:
a third ADC having a fifth ADC input and a sixth ADC input, the third ADC input coupled to the second multiplexer output;
a third multiplexer having a fifth multiplexer input, a sixth multiplexer input, and a third multiplexer output, the third multiplexer output coupled to the sixth ADC input;
a second measurement channel pin coupled to the fourth multiplexer input and to the sixth ADC input; and
a third measurement channel pin coupled to the fifth multiplexer input; and
wherein the busbar pin is coupled to the sixth multiplexer input.

11. The system of claim 10, further including a controller, and wherein:
each of the first, second, and third multiplexers has a respective selection input coupled to the controller; and
the controller is configured to control the first, second, and third multiplexers such that the busbar pin is connected to only one of the first, second, or third ADCs at any point in time.
